(19) United States
(12) Patent Application Publication
(10) Pub. No.: US 2008/0260919 A1
(43) Pub. Date: Oct. 23, 2008

(54) Color emulsion and emulsifying agent composition as well as use thereof

(76) Inventor: Andreas Klingenberg, Reinbek (DE)

Correspondence Address: FRIEDRICH KUEFFNER, 317 MADISON AVENUE, SUITE 910, NEW YORK, NY, 10017, US

(21) Appl. No.: 12/077,056

(22) Filed: Mar. 14, 2008

(30) Foreign Application Priority Data
Mar. 14, 2007 (DE) 20 2007 003 800.3

(51) Int. Cl. A23D 7/005; A23D 7/04; A23L 1/27

(52) U.S. Cl. 426/250; 426/602; 426/540; 426/519

(57) ABSTRACT

This invention relates to an emulsifying agent composition for emulsifying a liposoluble color in a foodstuff. This being, it is provided that the emulsifying agent composition comprises at least one lecithin and at least one sugar ester of fatty acids as well as an emulsifying agent composition for the emulsion.

This invention relates to a color emulsion, a method for the production thereof and uses of the color emulsion as well as an emulsifying agent composition for this purpose.

Colors have been used for a long time in the food industry for coloring foodstuff. However, these substances designated as food colors according to their purpose of use are not, in many cases, water soluble but liposoluble. Thus, an use of liposoluble substances in water containing foodstuff such as juices or lemonades is not easily possible.

However, liposoluble colors can be emulsified in water containing foodstuffs as oil-in-water emulsions. This being, the oil phase constitutes the dispersed phase while the aqueous phase constitutes the coherent phase.

The optical properties of the food color emulsions is substantially determined by the size of the oil droplets which are distributed in the aqueous phase. Emulsions of liposoluble colors in aqueous foodstuffs known by the prior art have a mean particle size of 1 to 50 micrometers. However, the thus obtained emulsions have unsatisfactory optical properties. This relates in particular to the transparency and the luminous intensity of the emulsions. Moreover, the quantity of the liposoluble color which is required to color the aqueous foodstuff is comparatively high since its yield is low.

It is known to emulsify liposoluble colors in water containing foodstuffs as oil-in-water emulsions. This being, the oil phase constitutes the dispersed phase, while the aqueous phase constitutes the coherent phase. Emulsifying agents which avoid a phase separation are used for stabilizing these emulsions. The liposoluble food colors are thus converted into water soluble colors by means of the emulsifying agents.

In foodstuffs, for example lecithin (E 322) or sugar ester of nutrient fatty acids (E 473) are used as emulsifying agents.

The selection of the emulsifying agent depends on the properties of the foodstuff and of the liposoluble color. When using liposoluble food colors for coloring fruit juices, it should be considered that fruit acids can cause a destruction of the emulsifying agent. For this reason, the use of acid resistant emulsifying agents is to be wished. However, the emulsifying agents known until now have mainly only a low stability to acid.

The WO 2007/026271 A discloses a stable microemulsion which contains lecithin and sugar ester of fatty acids as emulsifying agents.

According to the WO 01/08507 A, a mixture of emulsifying agents is known for a drink which contains lecithin and sugar ester as well as coffee whitener. Furthermore, the mixture does not refer to the emulsifying of carotenoids. Coffee whitener cannot be considered as a color for food, it is a food element, not a color.

From the WO 2005/122784 A, a food safe ink is known which contains lecithin and sorbitan ester as emulsifying agent. This food safe ink is suitable for printing edible substances and is not a foodstuff but serves for modifying (printing) foodstuffs.

An emulsifying agent system which contains lecithin and sugar glycerides and which forms stable emulsions with oil elements is known from the GB-A-1049335. The matter is here of the production of pastes or of milk products which contain eggs.

The EP-A-1 270 679 discloses a color mixture which can contain carotene and an emulsifying agent.

This emulsifying agent is selected from a group of emulsifying agents which is selected among lecithin, polysorbate 80, Lactene and/or Citrem. A combination of two emulsifying agents is not disclosed.

According to the GB 918 399 A, a water dispersible composition is known which contains lecithin as a emulsifying agent and which is suitable for example as a drink base. In these compositions, the carotene is not destroyed by the ascorbic acid which exists in fruit juices.

The JP 09084566 A discloses carotenoid containing drinks which contain sugar ester with fatty acids as emulsifying agent. The colors used here have an excellent stability to heat and light without being influenced by the pH value.

The US-B2-6 635 293 discloses carotenoids which are used for example in drinks and which contain emulsifying agents, selected from sugar esters and lecithin.

The DE 10 2005 031 467 A1 discloses an emulsion which contains a disperse phase which comprises a liposoluble substance, water as continuous phase and an emulsifying agent system. The liposoluble substance can be a color such as β-carotene. The carotenoids can be dissolved in oil, for example in sunflower oil. The manufacturing of the emulsion takes place by means of a high-pressure homogenizer, whereby the emulsion can be used for coloring drinks.

The aim of this invention is to eliminate the disadvantages according to the prior art. In particular a color emulsion should be proposed which has a higher transparency and a stronger light intensity. Moreover, the emulsion should cause a better yield of the color. Furthermore, an emulsifying agent composition for a color emulsion should be made available which has a high stability to acid and which thus makes possible the emulsifying of food colors in foodstuffs such as fruit drinks or fruit preparations.

This aim is achieved by the characteristics of claims 1 or 2.

According to the invention, an emulsion is provided which has an oil phase dispersed in an aqueous phase, whereby the oil phase is formed by a liposoluble color. This being, the mean size of the oil droplets from the dispersed food color which form the dispersed oil phase is 100 nm or less.

The color is preferably a food color.

The invention is based on the surprising assessment that the emulsion according to the invention has a higher transparency and a better light intensity than known emulsions of food colors. Moreover, because of the smaller size of the oil droplets, a better yield of the food color is achieved.

Emulsions with a dispersed oil phase, the mean oil droplet size of which is smaller than or equal to 100 nm, can be produced by means of high-pressure homogenizers known per se. This being, a raw emulsion or suspension is conveyed for example by means of a three-piston pump at a pressure up to 1500 bar through a nozzle system. Extreme shearing and elongation forces assure an efficient disintegration and a narrow droplet size distribution. A high turbulent mixing chamber assures a stabilization of the droplets and minimized disturbing coalescence effects. The emulsion according to the invention is preferably produced at a pressure of 300 to 1500 bar.

The emulsion according to the invention possesses, as already explained, a high transparency because of the low particle size. In a preferred embodiment, the emulsion is transparent. Moreover, it can be provided that the emulsion, when used for example in drinks, reaches a turbidity value (FNU value) lower than 100 and in the spectrophotometric analysis at 700 nm an adsorption factor lower than 0.1. The FNU value (“formazine nephelometric unit” is a parameter for measuring turbidity.

For the food color, the matter is preferably of a carotenoid. A particularly preferred food color is β-carotene. The invention is not limited to food colors but can also comprise liposoluble colors which are no food colors as oil phase.

The emulsion can comprise emulsifying agents for stabilizing the disperse oil phase in the aqueous phase. Emulsifying agents appropriate for foodstuffs comprise for example lecithin (E 322) or sugar ester of food fatty acids (E 473).

The emulsion according to the invention can be used for producing colored foodstuffs. Examples are colored drinks for the food industry, for example juices and lemonades. Due to the small particle size of the colors emulsified in the drinks, the drinks have a higher transparency and a better light intensity than known drinks.

For producing the emulsion according to the invention, a raw emulsion of an oil phase which contains the liposoluble color and of a coherent aqueous phase in which the oil phase is distributed is conveyed at a pressure of 300 to 1500 bar by means of a pump through the nozzle system of a high-pressure homogenizer. This being, the raw emulsion is conveyed under strong shearing and elongation forces so that an efficient disintegration of the oil phase into oil droplets and a narrow droplet size distribution is achieved. The oil droplets are stabilized in the high turbulent mixing chamber of the high-pressure homogenizer and disturbing coalescence effects are minimized so that the emulsion according to the invention is achieved.

The emulsion according to the invention is then added for example to a drink, preferably in a dosage of 0.1 to 2 g/kg drink, or to a yoghurt, preferably in a dosage of 0.5 to 3 g/kg yoghurt. This being, a transparent color is obtained.

The emulsifying agent composition for the emulsion for emulsifying at least one liposoluble color in a foodstuff is configured in such a manner that it comprises respectively with respect to the weight of the emulsifying composition
(a) between 30 and 70% in weight of at least one lecithin and
(b) between 30 and 70% in weight of at least one saccharose ester of fatty acids,
   whereby
the fatty acid is selected from the group which comprises palmitin acid, stearin acid, oil acid, laurinic acid and eruca acid;
the lecithin is selected from the group which comprises phosphatidycholine, phosphatidylethanolamine and phosphatidylinosite;
the liposoluble color is a carotenoid and
the foodstuff is a fruit drink or a fruit composition.

Thus, an emulsifying agent composition for emulsifying at least one liposoluble color in a foodstuff is provided which comprises at least one lecithin and at least one sugar ester of fatty acids.

The composition of the emulsifying agent which has been found is based on the surprising assessment that the emulsifying agent composition according to the invention has a high stability to acid. The stability to acid of the emulsifying agent composition according to the invention clearly exceeds that of the single components. For this reason, the emulsifying agent composition can be used for emulsifying food colors in foodstuffs with acid properties such as fruit drinks or fruit preparations. Moreover, the emulsifying agent composition according to the invention constitutes an efficient system for emulsifying liposoluble food colors.

Preferably, the sugar ester is a saccharose ester, particularly preferably a monoester of saccharose, a diester of saccharose or a triester of saccharose.

The fatty acid should be a food fatty acid. Preferably, the fatty acid is a saturated fatty acid or an unsaturated fatty acid, particularly preferably a fatty acid which is selected from the group which comprises palmitin acid, stearin acid, oil acid, laurinic acid and eruca acid. In case of a diester or triester of sugar, the estered fatty acids can be alike or different from each other.

Preferably, the sugar ester is a sugar ester of food fatty acids according to EC number E 473 (see Official Journal of the European Communities L 334/51, (DE 9.12.98). Accordingly, the sugar ester of fatty acids is a monoester, a diester and a triester of saccharose with food fatty acids. They can be produced from saccharose and the methyl esters and ethyl esters of the food fatty acids or by extraction from sugar glycerides.

The term “lecithin” designates here a substance according to EC number E 322 (see Office for official publications of the European Communities, CONSLEG: 1996L0077-Nov. 20, 2003). Accordingly, lecithin is defined as mixtures or fractions of phosphatides which are obtained by means of physical methods from food of animal or vegetal sources. Lecithins comprise also the hydrolyzed substances which are obtained with harmless and appropriate enzymes. The final product may not have any enzymatic residual activity. The terms “phosphatides” and “phospholipides” are used as synonyms for lecithins.

Preferably, the lecithin is selected from the group which comprises phosphatidylcholine, phosphatidylethanolamine and phosphatidylinosite. The lecithin phosphatidylcholine is particularly preferred.

The liposoluble color is preferably a food color, in particular a color which is selected from the group which comprises the carotenoids, chlorophylls or combinations thereof. In a particularly preferred embodiment, the liposoluble color is a carotenoid. The carotenoid can be selected from the group which comprises bixin, capsanthine, capsorubin, lutein, rhodoxanthin and combinations thereof.

The emulsifying agent composition comprises preferably (a) between 10 and 90% in weight of the at least one lecithin and (b) between 90 and 10% in weight of the at least one sugar ester of fatty acids; more preferably between (a) between 30 and 70% in weight of the at least one lecithin and (b) between 30 and 70% in weight of the at least one sugar ester of fatty acids, respectively with respect to the weight of the emulsifying agent composition.

Preferably, the emulsifying agent composition does not contain any further constituent but consists only of the at least one lecithin and the at least one sugar ester of fatty acids.

According to a preferred embodiment, the emulsifying agent composition comprises lecithin according to E 322 and sugar esters of food fatty acids according to E 473.

This emulsifying agent composition can be used in particular for emulsifying at least one liposoluble color in a foodstuff. For the foodstuff, the matter can be of sweets, drinks and yoghurt products. The emulsifying agent composition is preferably used for emulsifying one or several carotenoids in a fruit drink or in a fruit preparation. In particular, the emulsifying agent composition according to the invention which consists of lecithin according to E 322 and of sugar esters of food fatty acids according to E 473 is appropriate for emulsifying one or several carotenoids in a fruit drink, in a fruit preparation, a fruit refreshing drink, a milk product with fruit aroma without egg addition or a preparation of sweets. The particular appropriateness is based on the high stability to acid of the emulsifying agent composition according to the invention.

The invention will be explained below in more details by means of examples with reference to the attached drawings.

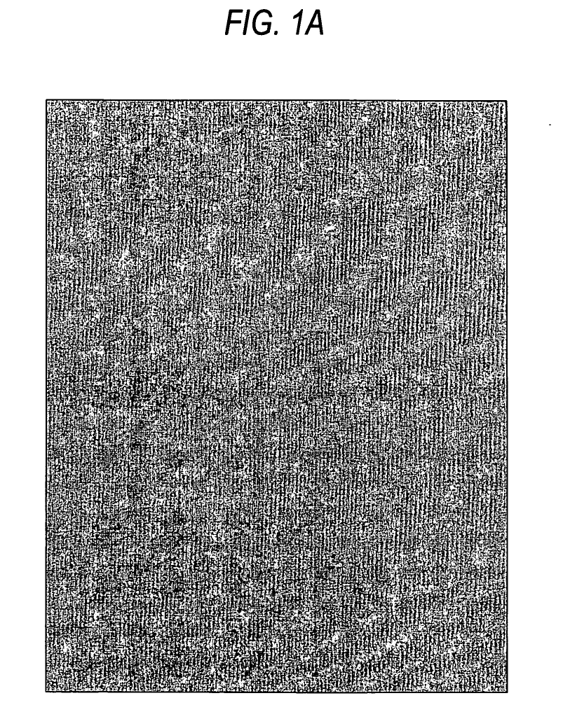

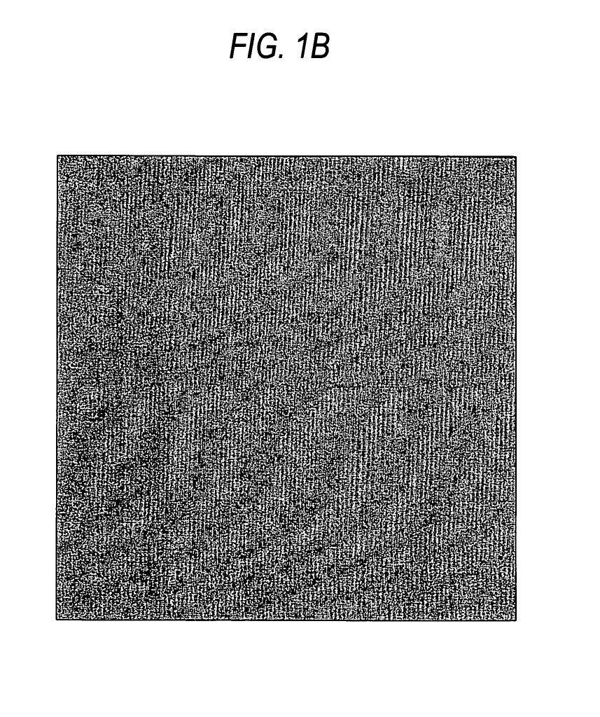

FIG. 1A shows a carotene emulsion according to the prior art with a particle size of approximately 1 mμ.

FIG. 1B shows a carotene microemulsion according to the invention.

The emulsion according to the invention is also designated below as microemulsion.

### EXAMPLES

### Comparative Example 1

### Oil-in-Water Emulsion with 1% in Weight Beta-Carotene

The starting materials indicated below have been made available for producing a comparative emulsion with a disperse beta-carotene containing oil phase and a coherent aqueous phase. The percentage indications refer to the whole recipe of the comparative emulsion:

(1) Oil phase:

| | |
|---|---|
| Lecithin E-322 | 2% in weight |
| Beta-carotene (crystalline) E-160a | 1% in weight |
| Sunflower oil | 10% in weight |
| Ascorbic palmitate E-304 | 1% in weight |
| Tocopherol E-307 | 1% in weight |

The components are mixed together and heated up to a temperature of 140° C. until all the carotene crystals are dissolved in the oil phase.

(2) Aqueous phase:

| | |
|---|---|
| Sugar ester E-473 | 2% in weight |
| Sorbitol syrup 70% E-420 | 77% in weight |
| Demineralized water | 6% in weight |

The components have been mixed by stirring and heated to 80° C.
(3) Mixing and Homogenization of the Raw Emulsion:

The oil phase has then been cooled to approximately 80° C. and added to the aqueous phase at 80° C. by stirring. After adding the oil phase into the aqueous phase, the mixture has been dispersed by a dispersing system and a traditional high-pressure homogenization system at approximately 300 bar to a particle size of the oil droplets of 90% approximately 1 mm. FIG. 1a shows a microscope image of the comparative emulsion with a particle size of approximately 1 μm.

### Example 1

### Microemulsion According to the Invention

The microemulsion according to the invention has been produced as in the comparative example, except that a high-pressure homogenizer with a high turbulent mixing chamber and pressure stages up to 1000 bar have been used to the homogeneous emulsifying of the oil phase in the aqueous phase. A particle size of the oil phase of 90% under 100 nm has been achieved. FIG. 1b shows a microscope image of the microemulsion according to the invention with a particle size of approximately 100 to 80 nm.

### Example 2

### Application Tests in End Products

The emulsion according to the invention and the comparative emulsion have been evaluated in the following applications:
(a) Mixing out in a Drink Base:

A drink with the following recipe has been produced:

| | | |
|---|---|---|
| Demineralized water | 1 | l |
| Invert sugar syrup (66 Brix) | 138 | g/l |
| Potassium sorbate | 0.2 | g/l |
| Sodium benzoate | 0.15 | g/l |
| Citric acid | 2 | g/l |
| Ascorbic acid | 0.1 | g/l |

For producing the drink, the water has been brought to the boil for a short time. Then, invert sugar syrup, potassium sorbate, natrium benzoate have been added and mixed. The so obtained drink base has been added to citric acid. Then, either the comparative emulsion (comparative drink), or the microemulsion according to the invention (drink of the example) has been added to the drink base with 0.5 g/kg with respect to the overall weight of the drink.
(b) Comparative Judgement of the Transparency

The FNU value of the drink of the example was with the comparative emulsion of approximately 800 FNU units while the turbidity value of the comparative drink was only approximately 80 FNU units. For the drink of the example, compared with the comparative drink, a transparent impression of color is achieved.

With the spectrophotometric analysis at 700 nm, an adsorption coefficient of less than 0.05 has been achieved for the drink of the example, while an adsorption coefficient of 0.3 has been assessed for the comparative drink.
(c) Comparative Judgement of the Color Yield and Light Intensity in the Drink

For the comparison of both drinks, an increase of the color yield by 15% confirmed by means of the L a b measurement has been assessed, as the microemulsion has been used compared with a traditional emulsion.

### Example 3

### Mixing out in a Yoghurt Base

The comparative emulsion (comparative yoghurt) or the microemulsion according to the invention (yoghurt of the example) have been mixed out and judged with respect to their color intensity.

A nature yoghurt with 3.5% fat has been used as a yoghurt base. For the comparative yoghurt 2 g/kg of the comparative emulsion, for the yoghurt of the example 2 g/kg of the microemulsion according to the invention have been added respectively for 30 minutes at ambient temperature.
(a) Comparative Judgement of Light Intensity and Yield

The comparative yoghurt had a light intensity of the yellow carotene of b:29, while the yoghurt of the example had a light intensity of b:32. The light intensity and yield have thus been increased by approximately 10% by using the microemulsion according to the invention.

The invention will be explained in more detail below by means of examples.

### Description of an Example of the Emulsifying Agent Composition in a 1% Acid Resisting Beta-Carotene o/w Emulsion

The following starting materials have been made available and processed as described for producing the emulsifying agent combination in a beta-carotene emulsion, the indications of percentages refer to the whole recipe of the color preparation:

1. Oil phase, contains lecithin E-322:

| | |
|---|---|
| Lecithin E-322 | 2% |
| Beta-carotene (crystalline) E-160a | 1% |
| Sunflower oil | 10% |
| Ascorbic palmitate E-304 | 1% |
| Tocopherol E-307 | 1% |

The components are mixed and heated to a temperature of 140° C. until all the carotene crystals are dissolved in the oil phase.

(2) Aqueous phase, contains sugar ester E-473:

| | |
|---|---|
| Sugar ester E-473 | 2% |
| Sorbitol syrup 70% E-420 | 77% |
| Demineralized water | 6% |

The components have been mixed by stirring and heated to 80° C.
(3) Mixing and Homogenization of the o/w Emulsion

The oil phase has then been cooled to approximately 80° C. and added to the aqueous phase at 80° C. by stirring. After adding the oil phase into the aqueous phase, the mixture has been dispersed by dispersing and high-pressure homogenization systems to 500 bar to a particle size of the oil droplets of 90%<1 my.
4. Application Tests in End Products

The beta-carotene emulsion 1% will be judged in the following applications:
4.1 Mixing out in a Fruit Preparation:

Recipe and production:

| | | |
|---|---|---|
| 1. | Mix | |
| | 560 g | water |
| | 150 g | sugar |
| | 0.35 g | potassium sorbate |

and heat to 60° C. in a small pot.

| | | |
|---|---|---|
| 2. | Mix | |
| | 50 g | sugar |
| | 2.5 g | apple pectine |

and add at 60° C., then heat to 93° C.

| | | |
|---|---|---|
| 3. | Mix and add | |
| | 50 g | water |
| | 50 g | starch (corn starch). |
| 4. | Add | |
| | 100 g | sugar |
| 5. | 1 g | citric acid |

to the mixture.

Heat the preparation for a few minutes to approximately 90° C.
Adjust the Brix value to 33 with water.
The fruit preparation base is mixed with citric acid.
The color carotene 1% is added with 1 g/kg to the ready fruit preparation.
4.2 Mixing out in a drink base:

Recipe and production:

| | | |
|---|---|---|
| Demineralized water | 1 | l |
| Invert sugar syrup (66 Brix) | 138 | g/l |
| Potassium sorbate | 0.2 | g/l |
| Sodium benzoate | 0.15 | g/l |
| Citric acid | 21 | g/l |
| Ascorbic acid | 0.1 | g/l |

The water is brought to the boil for a short time.
Invert sugar syrup, potassium sorbate, sodium benzoate are added and mixed.
The drink base is added to citric acid.
The color carotene 1% is dosed with 1 g/kg to the drink base.

5. Assessment of the Color Stability:

The carotene color 1% has been stable over a period of 8 weeks at constant light intensity without indication of separation or color degradation in both mixtures (fruit preparation, drink).

1. Emulsion which has an oil phase dispersed in an aqueous phase, whereby the oil phase is formed by a liposoluble color, wherein the mean size of the oil droplets from the dispersed food color which form the dispersed oil phase is 100 nm or less.

2. Emulsion according to claim 1, wherein the emulsion comprises an emulsifying agent composition for emulsifying at least one liposoluble color in a foodstuff which comprises, respectively with respect to the weight of the emulsifying agent composition,
(a) between 30 and 70% in weight of at least one lecithin and
(b) between 30 and 70% in weight of at least one saccharose ester of fatty acids,
whereby
the fatty acid is selected from the group which comprises palmitin acid, stearin acid, oil acid, laurinic acid and eruca acid;
the lecithin is selected from the group which comprises phosphatidycholine, phosphatidylethanolamine and phosphatidylinosite;
the liposoluble color is a carotenoid and
the foodstuff is a fruit drink or a fruit composition, a fruit refreshing drink, a milk product with fruit aroma (eggless) or a fruit preparation of sweets.

3. Emulsion according to claim 1, wherein the emulsion has been produced at a pressure of 300 to 1500 bar preferably by means of a high-pressure homogenizer.

4. Emulsion according to claim 1, wherein the emulsion is transparent with the light of a wave length which is situated in the range which is visible for the human eye.

5. Emulsion according to claim 1, wherein the emulsion has at 700 nm an adsorption coefficient lower than 0.1.

6. Emulsion according to claim 1, wherein the color is a food color, preferably a carotenoid or β-carotene.

7. Emulsion according to claim 2, wherein the aqueous phase is a drink destined for human consumption.

8. Emulsion according to claim 2, wherein the saccharose ester is a monoester of saccharose, a diester of saccharose or a triester of saccharose.

9. Emulsion according to claim 2, wherein in the case of a diester of saccharose or of a triester of saccharose the estered fatty acids can be alike or different from each other.

10. Emulsion according to claim 2, wherein the lecithin of the emulsifying agent composition is phosphatidylcholine.

11. Emulsion according to claim 2, wherein the emulsifying agent composition contains a carotenoid which is selected from the group which comprises bixin, capsanthine, capsorubin, lutein, rhodoxanthin and combinations thereof or which contains an alpha and beta carotene, lycopin or apocarotinal.

12. Emulsion according to claim 2, wherein the emulsifying agent composition comprises
(a) between 10 and 90% in weight of the at least one lecithin and
(b) between 90 and 10% in weight of the at least one sugar ester of fatty acids,
respectively with respect to the weight of the emulsifying agent composition.

13. Emulsion according to claim 2, wherein the emulsifying agent composition comprises
(a) between 45 and 55% in weight of the at least one lecithin and
(b) between 55 and 45% in weight of the at least one sugar ester of fatty acids,
respectively with respect to the weight of the emulsifying agent composition.

14. Method for producing an emulsion according to claim 1, wherein the emulsion is produced by means of a high-pressure homogenizer at a pressure of 300 to 1500 bar.

15. Use of an emulsion according to claim 1 in a foodstuff.

16. Use according to claim 15, whereby the emulsion is used in a drink which preferably contains 0.1 to 2 g of the emulsion per kg drink.

17. Use according to claim 16, wherein the drink has an adsorption coefficient at 700 nm of 0.1 or less.

18. Use according to claim 16, wherein the drink has a turbidity coefficient (FNU value) of 100 or less.

19. Use according to claim 15, whereby the emulsion is used in yoghurt which contains 0.5 o 3 g of the emulsion, preferably 2.0 g of the emulsion per kg yoghurt.

20. Use of an emulsifying agent composition in an emulsion according to claim 1 for emulsifying a carotenoid in a fruit drink or in a fruit composition.

21. Use according to claim 20, wherein an emulsifying agent composition is used which comprises
(a) between 45 and 55% in weight of at least one lecithin and
(b) between 55 and 45% in weight of at least one saccharose ester of fatty acids,
whereby
the fatty acid is selected from the group which comprises palmitin acid, stearin acid, oil acid, laurinic acid and eruca acid;
the lecithin is selected from the group which comprises phosphatidycholine, phosphatidylethanolamine and phosphatidylinosite.

22. Use according to claim 20, wherein the lecithin is phosphatidycholine.

23. Emulsion obtained by using an emulsifying agent composition according to claim 2, wherein the emulsion has the following overall recipe:
(a) oil phase

| | |
|---|---|
| Lecithin | 2% |
| β-carotene | 1% |
| Sunflower oil | 10% |
| Ascorbic palmitate | 1% |
| Tocopherol | 1% |

(b) aqueous phase

| | |
|---|---|
| Sugar ester | 2% |
| Sorbitol syrup (70%) | 77% |
| Demineralized water | 6%. |

24. Emulsifying agent composition for emulsifying at least one liposoluble color in a foodstuff which comprises, respectively with respect to the weight of the emulsifying agent composition,
(a) between 30 and 70% in weight of at least one lecithin and
(b) between 30 and 70% in weight of at least one saccharose ester of fatty acids,
whereby
the fatty acid is selected from the group which comprises palmitin acid, stearin acid, oil acid, laurinic acid and eruca acid;
the lecithin is selected from the group which comprises phosphatidycholine, phosphatidylethanolamine and phosphatidylinosite;
the liposoluble color is a carotenoid and
the foodstuff is a fruit drink or a fruit composition, a fruit refreshing drink, a milk product with fruit aroma (eggless) or a fruit preparation of sweets, for an emulsion
which has an oil phase dispersed in an aqueous phase, whereby the oil phase is formed by a liposoluble color, wherein the mean size of the oil droplets from the dispersed food color which form the dispersed oil phase is 100 nm or less.
